(19) United States
(12) Patent Application Publication
(10) Pub. No.: US 2013/0235061 A1
(43) Pub. Date: Sep. 12, 2013

(54) VIDEO PROCESSING APPARATUS AND SYSTEM FOR CORRECTING VIDEO SIGNAL

(71) Applicant: Tamon SADASUE, Kanagawa (JP)

(72) Inventor: Tamon SADASUE, Kanagawa (JP)

(73) Assignee: RICOH COMPANY, LTD.

(21) Appl. No.: 13/780,069

(22) Filed: Feb. 28, 2013

(30) Foreign Application Priority Data
Mar. 9, 2012 (JP) 2012-053793

(51) Int. Cl. G09G 5/02

(52) U.S. Cl. CPC G09G 5/02
USPC 345/589

(57) ABSTRACT

A video processing apparatus includes a display control unit that corrects an input video signal, wherein the display control unit is configured to calculate edge quantities based on pixel values of the input video signal to generate corrected pixel values in response to the edge quantities, and is configured to produce a corrected video signal that is obtained by alternately selecting, for a pixel of interest in successive frames, a corresponding one of the pixel values of the input video signal and a corresponding one of the corrected pixel values.

### BACKGROUND OF THE INVENTION

1. Field of the Invention

The disclosures herein generally relate to video processing apparatuses, and particularly relate to a video correcting technology that is used when supplying a video signal to an external apparatus that lacks sufficient ability to represent colors.

2. Description of the Related Art

A personal computer (PC) may be used to create presentation documents, the contents of which are then projected on a screen for an enlarged view by supplying a video signal from the PC to a projector. The colors that are visually checked on the liquid crystal display of the PC at the time of creating the documents may not necessarily coincide with the colors projected by the projector. Boundaries between different colors may not be distinct, which makes it difficult to see the boundaries. Areas that have different colors may appear to have the same color, which makes it impossible to see an intended image. When letters placed on a background end up having the same color as the background, these letters are not legible, thereby making it impossible to read an intended sentence.

These problems arise due to the fact that the projector has fewer numbers of colors that can be displayed than the liquid crystal display of the PC, and also arise because of a difference in the method of representing a video signal, which is called mapping. Further, these problems are not exclusive to the relationship between a liquid crystal display and a projector, but also occur in the case of using a liquid crystal display that has low ability to represent colors due to its limited bit width.

International Publication No. 2008/081594 discloses a technology that utilizes a scheme called frame rate control (FRC) to convert m-bit (m: integer) input data indicative of pixel luminance into n-bit (n: integer smaller than m) output data for controlling the luminance of each pixel. Frame rate control is a correction technology used in the case of using a display with a small number of gray levels, such as 64 RGB levels, to represent an image of a large number of gray levels such as 256 RGB levels. This control changes gray-level values at such short intervals that human vision cannot perceive the changes, thereby creating an intermediate pseudo gray level by utilizing the afterimage effect.

Further, Japanese Patent Application Publication No. 2010-176082 discloses a technology for displaying an image with a smooth appearance by utilizing the characteristics of human vision that exhibit decreased sensitivity to differences of pixel values as the luminance of the pixels increases. This technology selects and applies either dither correction or frame rate control as a gray-level correction method on a pixel-by-pixel basis in order to decrease the number of gray levels.

The technology disclosed in International Publication No. 2008/081594 can provide as many effectively perceived gray levels as the number of gray levels prior to conversion. However, this technology concerns the control of a liquid crystal display, and, thus, cannot be applied unless the characteristics of the liquid crystal display are known. Further, the fact that frame rate control is performed with respect to all the pixels in each frame gives rise to a problem of conspicuous flicker.

The technology disclosed in Japanese Patent Application Publication No. 2010-176082 can display a smooth image under expected circumstances. Since this technology utilizes the characteristics of human vision, however, correction responsive to image contents cannot be performed. Because of this, this technology cannot improve legibility of letters appearing in artificial images. Further, a fine line of a letter having a color close to the background color may be expanded through dither correction, which rather ends up degrading the legibility.

Accordingly, there is a need to provide a video processing apparatus that sufficiently improves visibility even for artificial images, without being affected by the characteristics of a display apparatus, and without creating flicker, even in the case of displaying video by the use of a display that can only represent a fewer number of colors than the number of colors used in an original video signal.

### SUMMARY OF THE INVENTION

It is a general object of at least one embodiment of the present invention to provide a video processing apparatus that substantially obviates one or more problems caused by the limitations and disadvantages of the related art.

In one embodiment, a video processing apparatus includes a display control unit that corrects an input video signal, wherein the display control unit is configured to calculate edge quantities based on pixel values of the input video signal to generate corrected pixel values in response to the edge quantities, and is configured to produce a corrected video signal that is obtained by alternately selecting, for a pixel of interest in successive frames, a corresponding one of the pixel values of the input video signal and a corresponding one of the corrected pixel values.

According to at least one embodiment, a color and gray level of an original pixel are maintained at a portion where visibility is not critical, and are replaced by those of a corrected pixel at a portion where visibility is critical. With this arrangement, visibility is sufficiently improved even for artificial images, without being affected by the characteristics of a display apparatus, and without creating flicker, even in the case of displaying video by use of a display that can only represent a fewer number of colors than the number of colors present in the original video signal. In particular, visibility is improved at a portion where visibility is critical such as a portion of a letter placed on a background.

### BRIEF DESCRIPTION OF THE DRAWINGS

Other objects and further features of embodiments will be apparent from the following detailed description when read in conjunction with the accompanying drawings, in which:

FIG. 1 is a drawing illustrating an example of the configuration of a video processing apparatus according to an embodiment;

FIG. 2 is a drawing illustrating an example of the configuration of a projector to which the video processing apparatus is applied;

FIG. 3 is a drawing illustrating an example of the configuration of a display control unit;

FIG. 4 is a flowchart illustrating an example of a procedure performed by the display control unit;

FIGS. 5A and 5B are drawings illustrating examples of edge detecting filters;

FIGS. 6A and 6B are drawings illustrating examples of horizontal-or-vertical-line detecting filters;

FIG. 7 is a drawing illustrating examples of portions where edges are detected;

FIG. 8 is a flowchart illustrating an example of another procedure performed by the display control unit;

FIG. 9 is a flowchart illustrating an example of yet another procedure performed by the display control unit; and

FIG. 10 is a flowchart illustrating an example of still another procedure performed by the display control unit.

### DESCRIPTION OF THE PREFERRED EMBODIMENTS

In the following, embodiments of the present invention will be described with reference to the accompanying drawings.

### First Embodiment

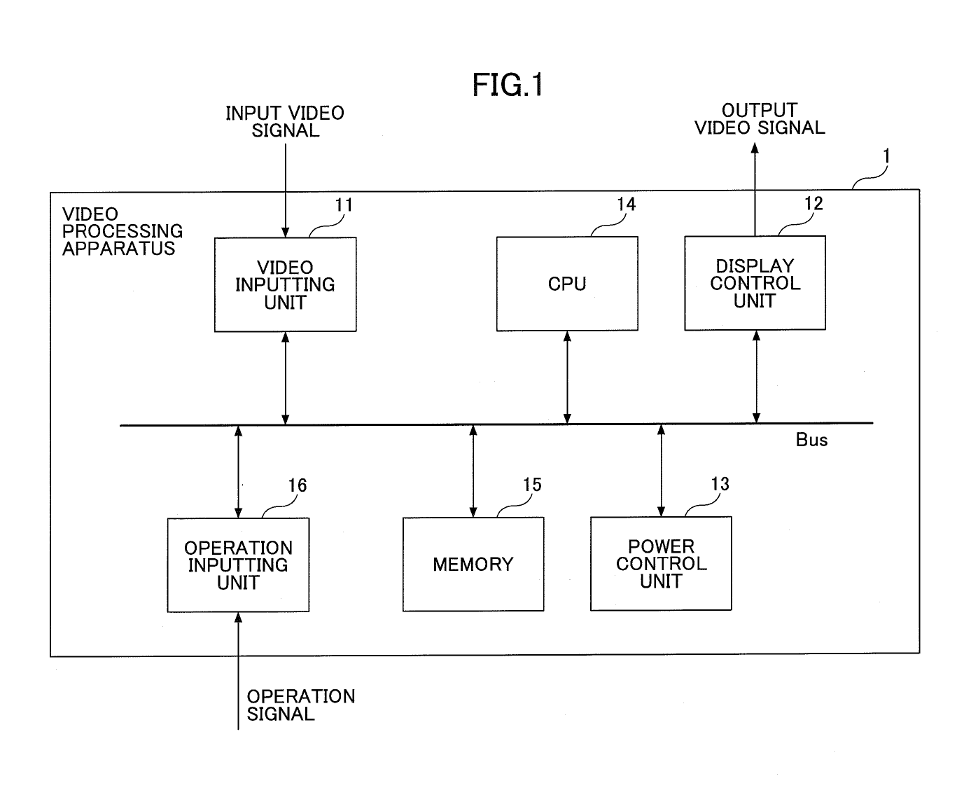

FIG. 1 is a drawing illustrating an example of the configuration of a video processing apparatus according to an embodiment.

A video processing apparatus 1 illustrated in FIG. 1 may be implemented as a video-processing-purpose LSI (large scale integration), and includes a video inputting unit 11, a display control unit 12, a power control unit 13, a CPU 14, a memory 15, and an operation inputting unit 16.

The video inputting unit 11 has the function of receiving a video signal from a camera, a video content player, or the like. The video inputting unit 11 may receive a video signal (video data) through a digital interface such as HDMI (High-Definition Multimedia Interface) or a DisplayPort, or may receive a video signal through an analog interface such as an analog VGA (Video Graphics Array). In the case of receiving an analog video signal, the video inputting unit 11 performs an AD conversion. The video signal is stored in the memory 15 connected to a main bus.

In another embodiment, a video signal is directly generated by a processor such as the CPU 14, rather than received through the video inputting unit 11, and is then stored in the memory 15. Such a video signal may be of a menu screen to be operated by a user or may be generated from a 3D model. Writing of a video signal to the memory 15 may be performed only upon the occurrence of a predetermined event, or may be performed at constant intervals. An example of the former is a menu screen, and an example of the latter is an animation generated from 3D models.

The display control unit 12 is called a display controller or the like. The display control unit 12 may read a video signal (i.e., video signal received from an external source or generated by the processor or the like) from the memory 15 at constant intervals, and corrects the video signal to improve visibility on a display device, followed by outputting the corrected video signal.

The power control unit 13 serves to optimize the consumption of electrical power in the video processing apparatus 1.

The CPU 14 serves to perform main control of the video processing apparatus 1.

The memory 15 serves to store video data and programs.

The operation inputting unit 16 serves to receive operation signals that are given to the video processing apparatus 1 from an external source.

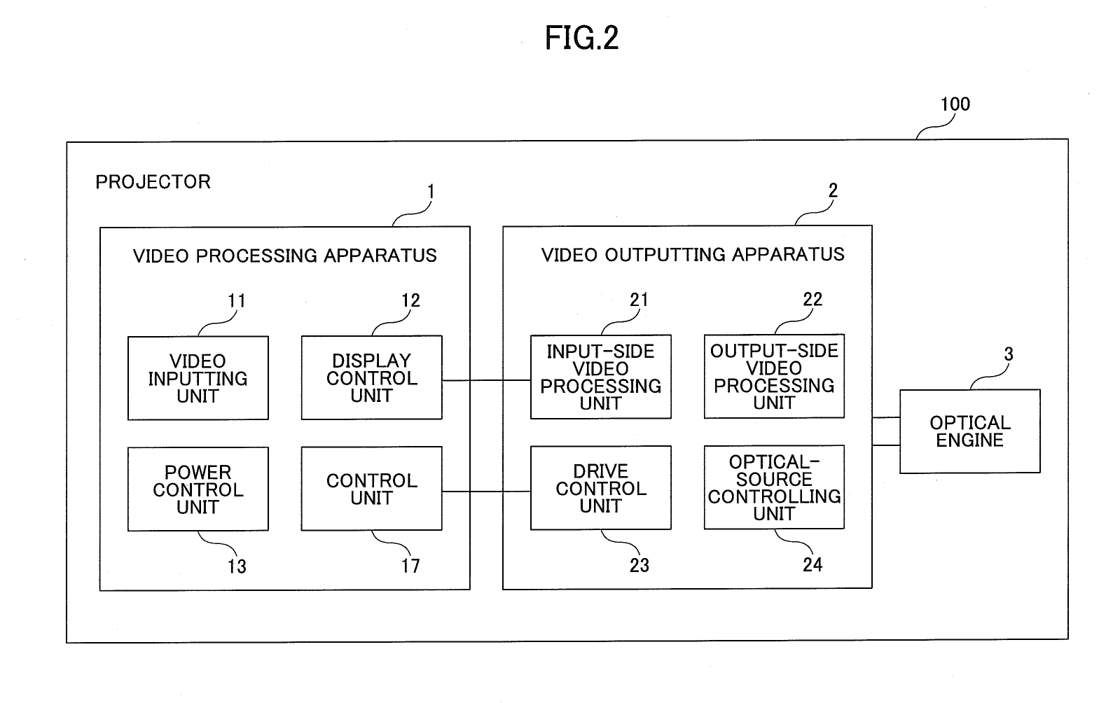

FIG. 2 is a drawing illustrating an example of the configuration of a projector to which the video processing apparatus 1 is applied.

In FIG. 2, a projector 100 includes the video processing apparatus 1, a video outputting apparatus 2, and an optical engine 3.

The video processing apparatus 1 corresponds to what is illustrated in FIG. 1, except that the CPU 14, the memory 15, and the operation inputting unit 16 illustrated in FIG. 1 are shown collectively as a control unit 17.

The video outputting apparatus 2 includes an input-side video processing unit 21, an output-side video processing unit 22, a drive control unit 23 for controlling the driving of the optical engine 3, and an optical-source controlling unit 24 for controlling the optical source of the optical engine 3.

The optical engine 3 includes the optical source, optical systems, a cooling mechanism, etc.

Instead of being applied to the projector 100 illustrated in FIG. 2, the video processing apparatus 1 may be implemented as a personal computer, in which case the video outputting apparatus 2 may be an external liquid crystal display. In such a case, the video processing apparatus 1 may be directly connected to the video outputting apparatus 2, or may be connected to the video outputting apparatus 2 through a network. Another example is that the video processing apparatus 1 and the video outputting apparatus 2 may be contained in a single case to be part of a note PC or a tablet terminal. In the manners as described above, various systems having the video processing apparatus 1 as one element thereof may be designed.

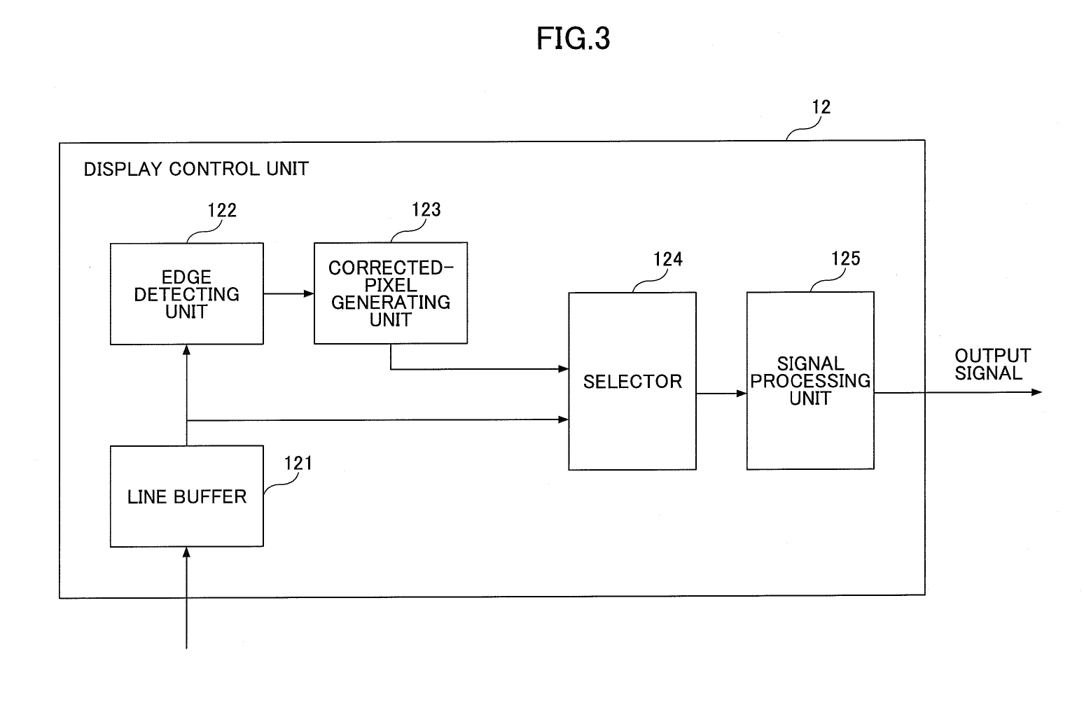

FIG. 3 is a drawing illustrating an example of the configuration of the display control unit 12 of the video processing apparatus 1 illustrated in FIG. 1.

In FIG. 3, the display control unit 12 includes a line buffer 121, an edge detecting unit 122, a corrected-pixel generating unit 123, a selector 124, and a signal processing unit 125.

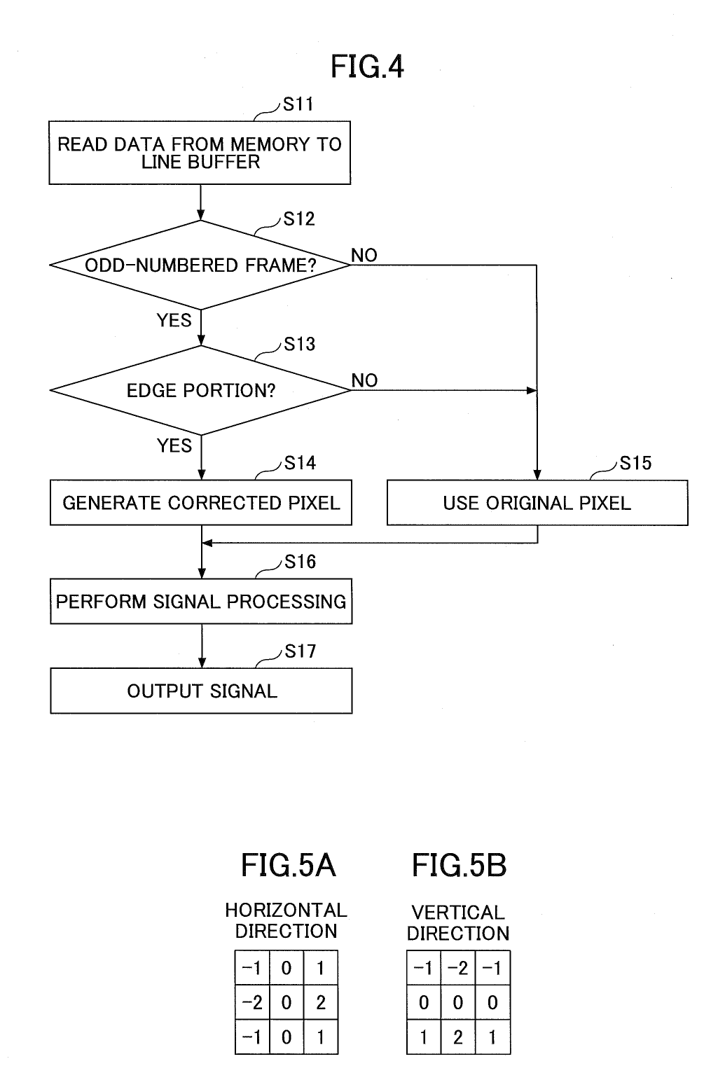

In the following, a description will be given of the operations of the respective units or blocks illustrated in FIG. 3 by referring to a flowchart illustrated in FIG. 4. A series of processes illustrated in FIG. 4 are performed for the output lines of one frame contained in a video signal, which are repeated at a given frame rate such as 60 frames per second.

In FIG. 4, the display control unit 12 transfers frame data from the memory 15 to the line buffer 121 (step S11). The line buffer 121 is a local memory for storing frame data for a plurality of lines. The line buffer 121 may be a FIFO (first in, first out) in which the oldest data is discarded upon a new line being written at the time of storing frame data.

The display control unit 12 checks whether the frame of interest is an even-numbered frame or an odd-numbered frame, and performs different processing depending on the check result (step S12). When the frame rate is 60 frames per second, for example, an original pixel value and a corrected pixel value are alternately output for successive frames such that the same pixel value lasts for only one frame, thereby generating an intermediate pseudo color based on the afterimage effect. In such a case, the corrected pixel may be generated and output only when the frame of interest to be output is an odd-numbered frame as counted from the first frame, for example. This arrangement is not intended to be a limiting example. When the frame rate is 90 frames per second, for example, an original pixel value may be selected for the first two frames of every three frames, and a corrected pixel value may be selected for the last frame of every three frames, thereby generating an intermediate color.

For an odd-numbered frame, the edge detecting unit 122 of the display control unit 12 checks whether an edge is present (step S13). Namely, the edge detecting unit 122 checks whether the pixel of interest is part on an edge (i.e., an image portion where pixel values exhibit a sudden change such as a portion of a letter placed in a background) based on the data of a plurality of lines stored in the line buffer 121.

The edge detecting unit 122 performs spatial filtering in a horizontal direction and in a vertical direction by use of 3-x-3 edge detecting filters (i.e., edge detecting Sobel filters) as illustrated in FIGS. 5A and 5B, for example, thereby producing edge quantities that are the results of spatial filtering. This filtering is performed with respect to each of the RGB colors. The pixel of interest is found to be part of an edge when either the sum of squares of RGB edge quantities obtained by the horizontal direction filtering or the sum of squares of RGB edge quantities obtained by the vertical direction filtering exceeds a threshold. This arrangement is used in order to avoid a case in which the step of reducing the number of gray levels by discarding one or two lower-order bits causes two different colors separated by a significant color distance to end up being mapped to the same color when differences of the pixel values are small with respect to each of the RGB colors.

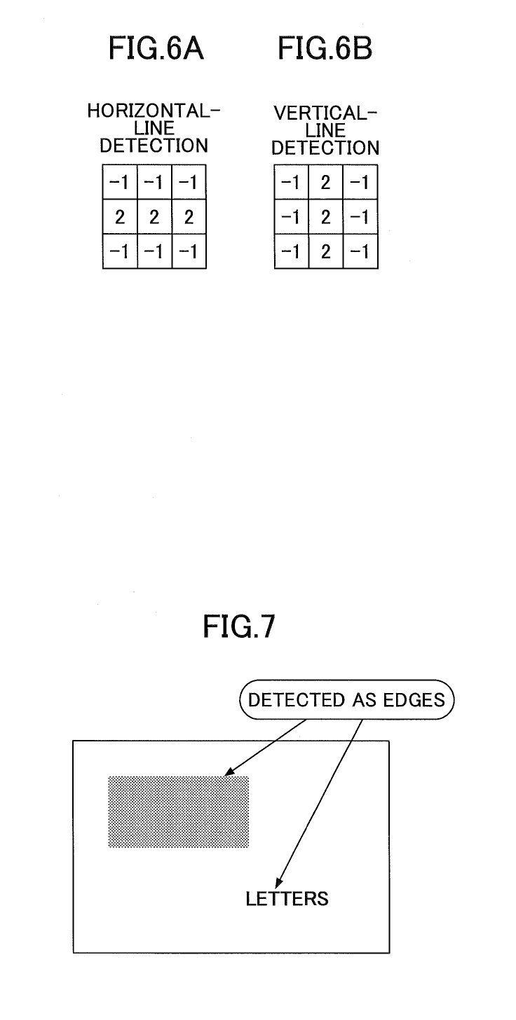

In another example, horizontal-or-vertical-line detecting filters as illustrated in FIGS. 6A and 6B are used. In this case also, the pixel of interest is found to be part of an edge by using the same edge-quantity threshold criteria as described above. Edge detection may be made easier by applying a smoothing filter prior to the application of edge detecting filters.

The edge detecting filters described above effectively detect an edge, thereby allowing a block portion and a letter portion contained in an artificial image to be detected with sufficient accuracy as illustrated in FIG. 7.

By referring to FIG. 4 again, the display control unit 12 uses the corrected-pixel generating unit 123 to generate a corrected pixel for the pixel that is found to be part of an edge, and replaces the pixel with the corrected pixel (step S14). Such correction is made by inverting the one or two upper-order bits of the pixel, for example. This alteration changes the pixel value significantly, which causes the pixel of interest to have a different color appearance than neighboring pixels due to the afterimage effect when the original pixel value and the corrected pixel value are alternately presented. Namely, borders are clearly visible. The above-noted arrangement alters pixel values only in small local areas rather than changing pixel values of an entire image as does the frame rate control scheme, thereby avoiding the generation of needless flickers.

The original pixel value is used without any change for the frames other than the odd-numbered frames and also for the pixels that are not found to be part of an edge (step S15). With this arrangement, no flicker occurs at portions where pixel values gradually change.

Subsequently, the display control unit 12 performs predetermined signal processing (step S16). This signal processing performs adjustment for the purpose of making it possible for a device at the receiving end to receive the video signal. In general, signals received by an LCD (i.e., liquid crystal display) include, in addition to a pixel value signal, a clock signal, a horizontal synchronizing signal, and a vertical synchronizing signal, all of which may need to be output in synchronization with receivable frequency. To this end, the above-noted signal processing adjusts these signals.

Subsequently, the display control unit 12 outputs the video signal after the signal processing to signal lines (step S17).

### Second Embodiment

According to this embodiment, the display control unit 12 additionally performs the process of reducing the number of gray levels in conformity with the display device. The configuration of the display control unit 12 is the same as the configuration illustrated in FIG. 3.

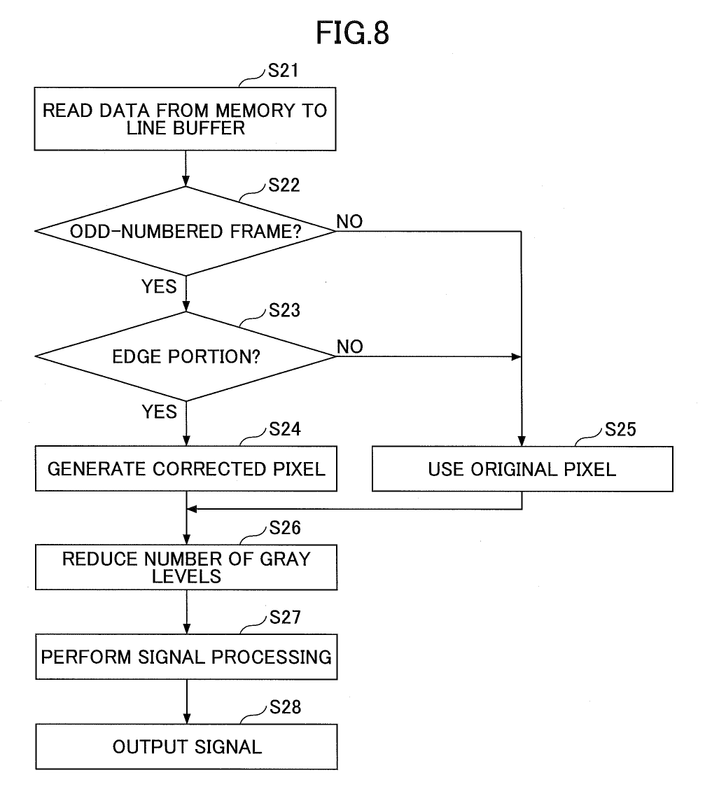

FIG. 8 is a drawing illustrating an example of the processes performed by the display control unit 12 according to the present embodiment. Steps S21 through S25 are identical to steps S11 through S15 illustrated in FIG. 4, respectively. Further, steps S27 and S28 are identical to steps S16 and S17 illustrated in FIG. 4, respectively.

In the present embodiment, the process of reducing the number of gray levels is performed in step S26 prior to the signal processing of step S27.

In the case of a full-color configuration, video signals generated by a processor typically have 8-bit (256) gray levels in each of the RGB colors. Such signals may be connected to a liquid crystal display for which the gray levels of each of the RGB colors are represented by 6 bits. In this case, conversion from 8 bits to 6 bits is performed as the process of reducing the number of gray levels. The process of reducing the number of gray levels includes a method of using the six upper-order bits after discarding the two lower-order bits and also a method of using a conversion table (e.g., LUT: lookup table) prepared in advance.

In the present embodiment, a post-correction pixel value and a pre-correction pixel value at the position found to be part of an edge need to be different even after the process of reducing the number of gray levels. Namely, provision may be made such that the process of generating a corrected pixel value changes at least one of the six upper-order bits when the process of reducing the number of gray levels discards the two lower-order bits.

### Third Embodiment

The two embodiments described heretofore constantly generate a corrected pixel value for pixel replacement at an edge portion. The function of switching modes in response to a user operation may be added to provide a choice between the mode in which an original pixel value is always output and the mode in which a corrected pixel value is generated to replace the original pixel value at an edge portion similarly to the two previous embodiments.

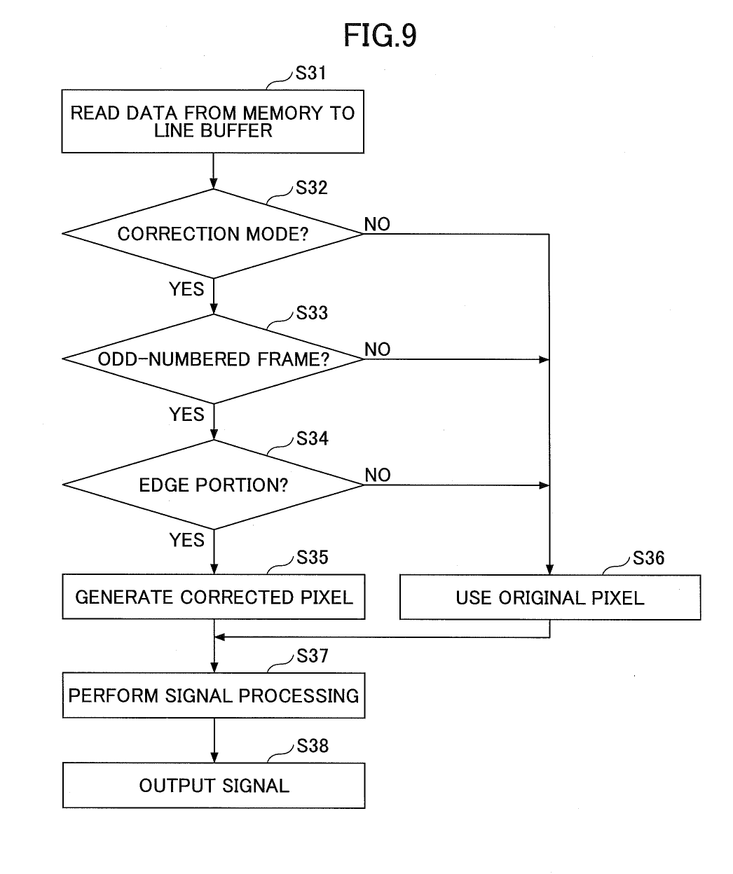

FIG. 9 is a flowchart illustrating an example in which the function of switching processes according to the mode is added to the flowchart of FIG. 4.

In FIG. 9, steps S31 and S33 through S38 are identical to steps S11 through S17 illustrated in FIG. 4, respectively.

In FIG. 9, a check is made in step S32 as to whether the mode selected by a user is a correction mode. Upon detecting that the mode is a correction mode, the same procedure as illustrated in FIG. 4 is performed. In the case of a mode other than the correction mode, the procedure proceeds to step S36, in which an original pixel value is used.

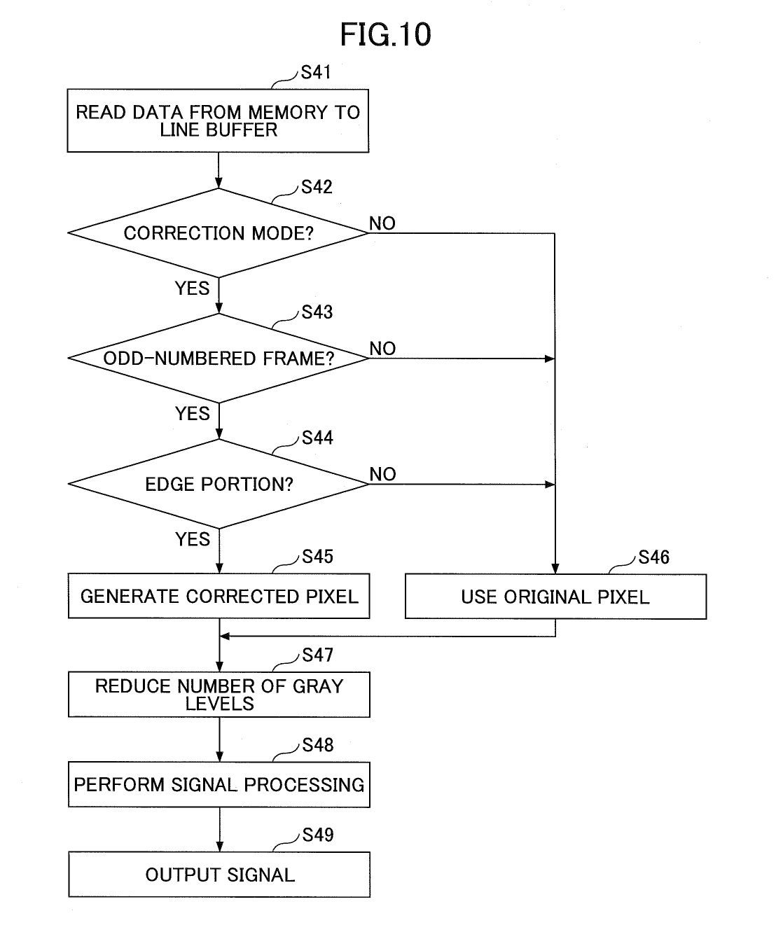

FIG. 10 is a flowchart illustrating an example in which the function of switching processes according to the mode is added to the flowchart of FIG. 8.

In FIG. 10, steps S41 and S43 through S49 are identical to steps S21 through S28 illustrated in FIG. 8, respectively.

In FIG. 10, a check is made in step S42 as to whether the mode selected by a user is a correction mode. Upon detecting that the mode is a correction mode, the same procedure as illustrated in FIG. 8 is performed. In the case of a mode other than the correction mode, the procedure proceeds to step S46, in which an original pixel value is used.

### SUMMARY

As described above, a color and gray level of an original pixel are maintained at a portion where visibility is not critical, and are replaced by those of a corrected pixel at a portion where visibility is critical. With this arrangement, visibility is sufficiently improved even for artificial images, without being affected by the characteristics of a display apparatus, and without creating flicker, even in the case of displaying video by use of a display that can only represent a fewer number of colors than the number of colors present in the original video signal. In particular, visibility is improved at a portion where visibility is critical such as a portion of a letter placed on a background.

Embodiments of the present invention have been described heretofore for the purpose of illustration. The present invention is not limited to these embodiments, but various variations and modifications may be made without departing from the scope of the present invention. The present invention should not be interpreted as being limited to the embodiments that are described in the specification and illustrated in the drawings.

The present application is based on Japanese priority application No. 2012-053793 filed on Mar. 9, 2012, with the Japanese Patent Office, the entire contents of which are hereby incorporated by reference.

What is claimed is:

1. A video processing apparatus, comprising a display control unit that corrects an input video signal,
wherein the display control unit is configured to calculate edge quantities based on pixel values of the input video signal to generate corrected pixel values in response to the edge quantities, and is configured to produce a corrected video signal that is obtained by alternately selecting, for a pixel of interest in successive frames, a corresponding one of the pixel values of the input video signal and a corresponding one of the corrected pixel values.

2. The video processing apparatus as claimed in claim 1, wherein the display control unit outputs a video signal obtained by reducing a number of gray levels of the corrected video signal.

3. The video processing apparatus as claimed in claim 1, further comprising a mode switching unit configured to select a correction mode or one or more other modes, wherein the display control unit outputs the corrected video signal in the correction mode, and outputs the pixel values of the input video signal for all the successive frames in the one or more other modes.

4. The video processing apparatus as claimed in claim 1, further comprising a mode switching unit configured to select a correction mode or one or more other modes, wherein the display control unit outputs a video signal obtained by reducing a number of gray levels of the corrected video signal in the correction mode, and outputs a video signal obtained by reducing a number of gray levels of the input video signal for all the successive frames in the one or more other modes.

5. The video processing apparatus as claimed in claim 1, wherein the calculation of the edge quantities is performed by applying spatial filtering.

6. The video processing apparatus as claimed in claim 1, wherein the display control unit includes a memory to temporarily store a plurality of lines of the input video signal, and the calculation of the edge quantities is performed by applying spatial filtering to the plurality of lines stored in the memory.

7. A video processing system, comprising the video processing apparatus of claim 1.
